(19) United States
(12) Patent Application Publication
(10) Pub. No.: US 2015/0128872 A1
(43) Pub. Date: May 14, 2015

(54) Rodent Cage

(71) Applicants: Steven T. Marsh, Peoria, AZ (US); Norman C. Wang, Phoenix, AZ (US)

(72) Inventors: Steven T. Marsh, Peoria, AZ (US); Norman C. Wang, Phoenix, AZ (US)

(21) Appl. No.: 14/077,839

(22) Filed: Nov. 12, 2013

(51) Int. Cl. A01K 1/03; A01K 1/01

(52) U.S. Cl. CPC A01K 1/031; A01K 1/01
USPC 119/417; 119/480; 119/479; 119/473

(57) ABSTRACT

A rodent cage for housing a rodent comprises a cage body having an open bottom end and an open top end defined by integral sidewalls. An interior surface of each sidewall is adapted to carry a channel. The top end of at least one sidewall terminates below the channel to slidably accept a top panel within the channel. The top panel has at least one opening therein for passage of laboratory equipment. A tray having a bottom and upwardly extending integral tray sidewalls is proportioned so that the cage body rests within the tray during use. The cage body further includes a floor of parallel spaced rods such that bedding housed within the cage body passes through the spaces between the rods while the rodent remains within the cage body when the cage body is removed from the tray. The rodent cage is constructed of a non-permeable clear acrylic plastic.

### TECHNICAL FIELD

The present invention relates to rodent cages; more particularly, to rodent cages used in scientific research; and most particularly, to rodent cages used during neuroscience-related research where a rodent within the cage is tethered to equipment outside of the cage.

### BACKGROUND OF THE INVENTION

In vivo testing of non-human animals, such as rodents, is essential in many avenues of scientific research. These studies are of particular importance within the neuroscience community as these studies provide valuable insights into the causes and physical manifestations of neurologic disorders as well as indications as to the effectiveness of pharmaceutical treatments of such disorders. Rats and mice are the typical subject animals in neuroscience research. During the course of a study, individual rats or mice are housed within a specialized cage where the animal can be monitored, administered medications or subjected to other research objectives, depending on the goals of the study. Ideally, the rat or mouse should experience minimal influence from laboratory personnel to ensure that the animal's activity is indicative of a “normal” state and is not a result of outside stresses experienced by the animal. Depending upon the research project's design and goals, the rat or mouse may be tethered to equipment located outside of the rodent cage. For instance, the rat or mouse may be hooked up to a drug infusion system, contacted with leads for electrical stimulation or electroencephalography or have a cannula surgically implanted within the skull to enable micro-dialysis infusion/collections of brain or spinal fluids.

There are a number of scientific related rodent cages available. However, each of these cages suffers from one or more significant drawbacks. For instance, one example of a typical rodent cage simply employs a generally cuboidal cage of metal lattice. The floor of the cage is of a lattice construction, such as a wire mesh, allowing for the rodent's urine and feces to pass through the floor to a waste collection bin below the mesh floor. As the rodent lives directly on the metal lattice of the cage bottom, the absence of bedding makes for a highly artificial environment. The metal sides and top also obscure visual observations and limit video monitoring of the rodent. Additionally, the rodent must be handled by laboratory personnel when needing to clean the rodent cage—typically on a daily basis. During the cleaning process, a researcher risks being bitten by the rodent when the rodent is moved from the cage or back into the cage. If left tethered to the external equipment, the experiment can be lost if the tether becomes dislodged from the rodent while the rodent is being moved. If purposely untethered during the cleaning process to avoid loss of the experiment, any data recording or drug infusion must be stopped while the animal is untethered, resulting in the interruption of the experiment.

Alternative cages, particularly those specifically designed for tethered experiments, particularly those where the goal is to eliminate the need to remove any tethers during cleaning, employ a cage construction which has open tops. Thus, a rodent can simply be lifted out of the cage when cleaning. However, the rodent must still be handled by research personnel leading to the same issues described above. Additionally, cages with open tops present difficulties because neuroscience research animals often have pathologies that require complete enclosures. For example, those with epilepsy may have violent seizures during which those animals can jump out of the cage and become suspended by the tethered system. In these instances, the researcher must again handle the animal to return it to its cage. Further, as these are paroxysmal events, if this occurs when no one is present, there is a risk of damage to the scientific equipment as well as to the animal (such as injury, dehydration or death).

What is needed in the art is a rodent cage which addresses the above recited limitations in the art. What is needed is a rodent cage which more closely mimics the living environment of a rodent while also allowing cleaning of the rodent cage with no direct contact with the animal and minimal disturbance to the enclosure. Further needed is a rodent cage having a complete enclosure which is also amenable to unobstructed visual and/or video monitoring of the rodent within the cage.

### SUMMARY OF THE INVENTION

Briefly described, a rodent cage for housing a rodent in accordance with the present invention generally comprises a cage body having an open bottom end and an open top end defined by integral sidewalls. A channel is situated within an interior surface of at least two opposing walls proximate the top end. The top end of at least one sidewall terminates below the channel thereby enabling slidable engagement of a top panel within the channel. The top panel has at least one opening therein for passage of laboratory equipment. A tray having a bottom and upwardly extending integral tray sidewalls is proportioned so that the cage body rests within the tray during use.

A further embodiment of a rodent cage according to the present invention includes provision of a cage body further including a floor proximate the bottom end of the body. Preferably, the floor is comprised of a plurality of parallel bars and lateral spaces between the bars proportioned such that bedding housed within the cage body passes through the spaces while the rodent remains within the cage body when the cage body is removed from the tray.

Yet another embodiment of a rodent cage according to the present invention includes a the top panel having a plurality of openings therethrough wherein at least one of the openings coincides with an edge of the top panel so as to allow slidable removal of the top panel from the cage body without requiring removal of the laboratory equipment.

In each of the above embodiments, the cage body, top panel and tray may be constructed of any suitable material, but in a preferred embodiment are constructed of a clear plastic; and more preferably constructed of a non-permeable clear acrylic plastic.

### BRIEF DESCRIPTION OF THE DRAWINGS

The above-mentioned and other features are advantages of this invention, and the manner of attaining them, will become apparent and be better understood by reference to the following description of the invention in conjunction with the accompanying drawings, wherein:

FIG. 1 is a perspective view of an embodiment of a rodent cage for housing a rodent in accordance with the invention;

FIG. 1A is an expanded view of a side wall with channel and top panel in accordance an embodiment of a rodent cage for housing a rodent of the invention;

FIG. 1B is a sectioned view of the rodent cage showing a top panel locking feature in accordance with the invention;

FIG. 2 is a cut-away side view of the assembled rodent cage in accordance with the invention; and

FIG. 2A is cut-away side view of the rodent cage with the tray bottom removed from the cage body for cleaning, in accordance with the invention.

### DESCRIPTION OF THE PREFERRED EMBODIMENTS

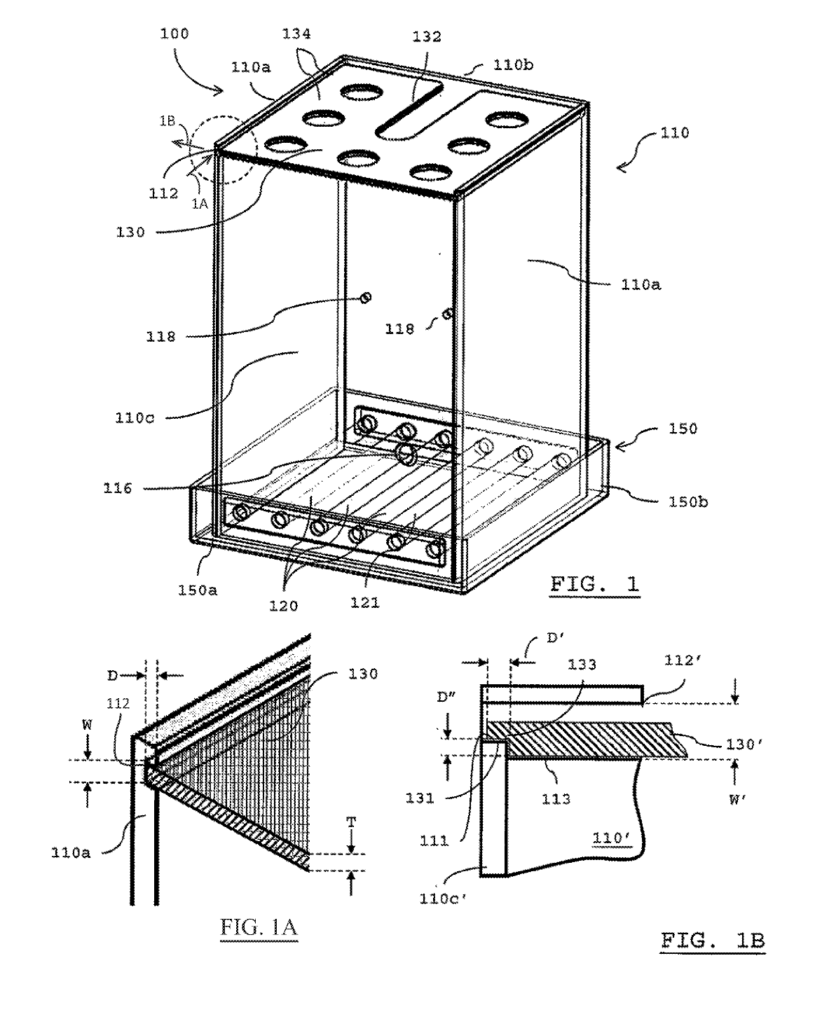

Referring to the drawings in detail, and specifically to FIGS. 1 and 1A, rodent cage 100 is generally comprised of three components: cage body 110, slide-in top panel 130 and tray 150 that slidably fits to the bottom of the cage body. Rodent cage 100 may be constructed of any suitable materials, but in a preferred embodiment is constructed of a clear plastic; and more preferably of a non-permeable clear acrylic plastic. Being constructed completely of clear plastic permits visual observation and video recording of the rodent within the cage without the obstacles associated with rodent's cages which use metal components. While it is understood that one skilled in the art could construct a rodent cage of the present invention in any size as determined by a particular need, in an embodiment for use with rats, the rodent cage generally measures about 9 inches wide by about 9 inches deep and about 14 inches tall. An embodiment for use with mice generally measures about 6 inches wide by about 6 inches deep and about 8¾ inches tall. Again, while any suitable material may be used in their construction, both the rat and mouse cages may be constructed of ¼ inch thick, 100% non-permeable clear acrylic.

Cage body 110 is generally comprised of integral sidewalls which define an open top end and open bottom end. While the cage body may be formed in any desired shape (i.e. round, square, rectangular, polygonal, etc.), in a preferred embodiment the rodent cage is generally a square or rectangular shape, which allows for the cages to be efficiently stacked when not in use, and includes opposing sidewalls 110a, a rear wall 110b and a front wall 110c. Proximate the top edge of each sidewall 110a and facing the interior of the cage body is channel 112 having a channel width “W” and depth “D” (see FIG. 1A). Channel depth “D” is a measure of the depth of the channel within plastic panel comprising sidewall 110a. Preferably, depth “D” is approximately one-half the total thickness the sidewall. Channel width “W” is selected to be slightly larger than thickness “T” of top panel 130. In this manner, top panel 130 slidably engages the channel 112 and is restricted from horizontal movement by the top and bottom walls of the channel.

To permit slidable removal and replacement of the top panel, the top edge of front wall 110c is situated below the channel so as not to obstruct movement of the top panel. Rear wall 110b may also be constructed to have its top edge below the channel to permit sliding of the top panel from either the front or rear. More preferably rear wall 110b has a length generally equal to that of the sidewalls and provides a backstop when slidably inserting the top panel. The rear wall 110b may further include a similar channel 112 to further assist in trapping the top panel.

Referring to FIG. 1B, an optional locking feature may be provided to prevent top panel 130′ from being inadvertently slid away from full engagement with body 110′. Groove 131 is added along the full length of the trailing edge of top panel 130′ that is adjacent front wall 110c′ when the top panel is fully engaged with body 110′. Groove depth D′ is selected to be approximately equal to the thickness of front wall 110c′ and groove depth D″ is selected to be approximately ¼ the thickness of top panel 130′ to form top panel ridge 133. In this embodiment, the bottom edge 113 of channel 112′ is disposed below top edge 111 of front wall 110c′ and width W′ of channel 112′ is selected to greater than the thickness of top panel 130′ to permit top panel 130′ to engage channel 112′ and to slide freely within channel 112′ when the top panel is brought in full engagement with body 110′. At the end of its engagement travel with body 110′, groove 131 is configured to receive top edge 111 of the front wall, allowing top panel 130′ to drop down and to engage edge 111 of the top wall with top panel ridge 133. In this manner, top panel 130′ cannot be inadvertently slid away from body 110′ without first lifting the top panel away from the body to disengage top panel ridge 133 from top edge 111 of the front panel.

Front wall 110c may further include provisions for a water bottle. For instance, front wall 110c may include spout hole 116. Spout hole 116 is preferably situated at about a 58° downward angle to allow one-way passage of the spout through the wall. Two additional holes 118 may be provided to allow for a restraint, such as a spring, cord or bungee, to support the upper end of the water bottle when in position. Preferably, holes 116 and 118 are situated within front wall 110c such that the rodent within the cage can easily access the water spout when desired.

In a preferred embodiment, opposing sidewalls (i.e. sidewalls 110a or front wall 110c/rear wall 110b) carry a plurality of corresponding evenly spaced through-holes proximate the bottom end of the cage body. A plurality of acrylic rods 120 is secured within respective corresponding opposing holes so as to form a floor. Each successive rod is arranged generally in parallel spaced relation with its preceding rod so as to form a lateral space 121 between adjacent rods. Lateral spaces 121 allow soiled bedding to pass between the rods during cleaning of the cage, while the rods are spaced in close enough proximity to one another to prevent the rodent from slipping between the rods or otherwise escaping the cage during the cleaning process. In this manner, the bedding may be refreshed without requiring handling of the rodent or removal of any tethered connections mounted onto the rodent. While disclosed as cylindrical rods 120, it is anticipated that one skilled in the art would understand that any suitable shape flooring could be used, such as tubes or bars having a square or rectangular cross-section.

Slidable top panel 130 is proportioned to include a thickness “T” such that the panel snugly slides within the channel 112 defined by sidewalls 110a with the top panel secured within the channel thereby preventing or minimizing horizontal movement of the panel. In this manner, a rodent within the cage cannot jump out of the cage when the top panel is in place. To allow research equipment to be tethered to the rodent within the cage, the top panel is equipped with one or more through-holes 134. In a preferred embodiment, at least one through-hole is adapted to be generally oblong in shape and intersect with an edge of top panel thereby forming a slotted indentation 132. Ideally, the edge of top panel 130 incorporating indentation 132 is directed into channel 112 so that the indentation 132 rests against rear sidewall 110b, with tethered leads, tubing, or other lines passing through the indentation opening. These research materials are retained in place by the three edges forming the indentation and the rear wall 110b. When cleaning the cage, the top panel may be withdrawn from the channel 112 without requiring handling of the rodent or detachment of the tethers. New bedding material can be dropped into the cage body from the open top followed by slidably replacing the top panel when complete. The remainder of through-holes 134 provide for extra ventilation and air circulation.

Tray 150 includes a tray bottom 150a and integral tray sidewalls 150b. Tray 150 is sized so that cage body 110 sits within the tray when the rodent cage is in use. In a preferred embodiment, tray sidewalls 150b are proportioned such that their upper ends extend at least above the height of the floor rods 120 situated within the cage body. Thus, when cleaning the cage and refilling with bedding, tray 150 collects all of the soiled bedding for disposal.

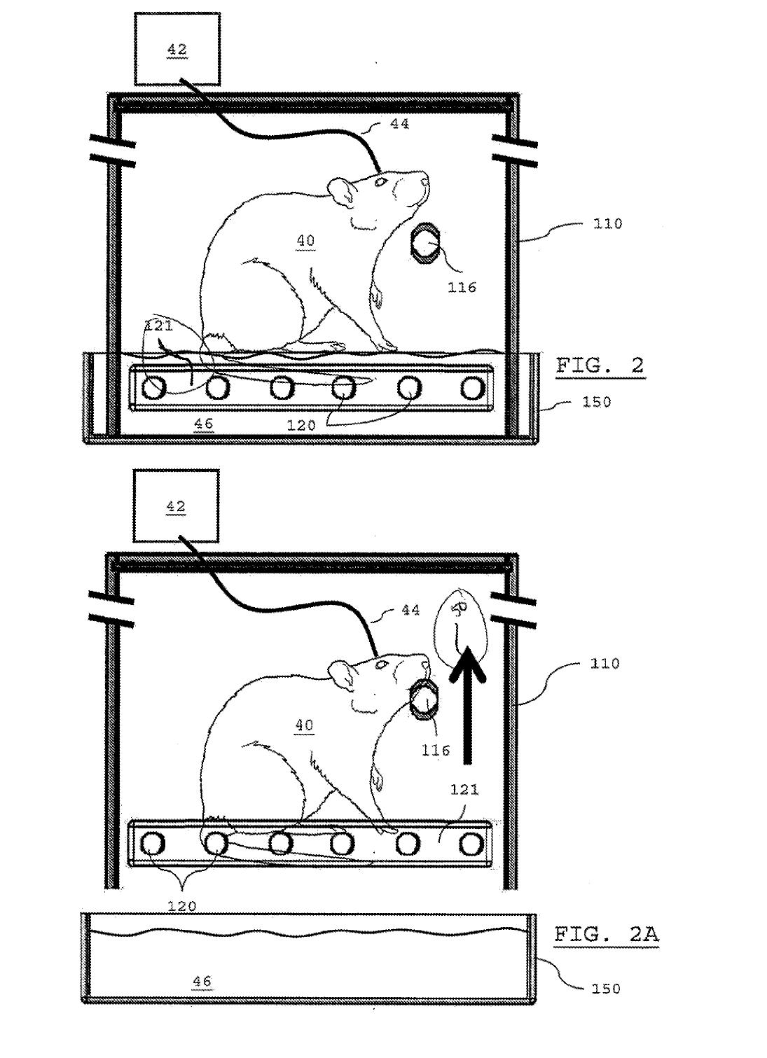

The rodent cage 100 of the present invention provides a more efficient and safer method of cleaning a rodent cage during an on-going experiment. Referring to FIGS. 2 and 2A, initially, a rodent 40 is placed within the rodent cage with any required or desired research equipment 42 connected to the rodent via tether 44. To clean the cage/refresh the bedding, cage body 110 is elevated out of the tray 150, while the rodent is still in the cage and tethered to the equipment, such that soiled bedding 46 (such as wood shavings with urine and feces) passes through lateral spaces 121 of the cage floor. This soiled bedding is collected within the tray. Rods 120 retain the rodent within the cage body while the cage body is elevated. The collected soiled bedding is then discarded and tray 150 is replaced beneath the cage body 110. At this point the rodent is still supported by the rods 120 and remains in a relatively calm state. To replenish the bedding materials, top panel 130 is slid out of channel 112 to open the top end of the cage body. Importantly, indentation 132 (FIG. 1) obviates the need to handle the rodent, remove any tethers or disconnect any equipment prior to removing the top panel. With the top panel removed, new bedding can be placed around the rodent within the cage body. Tray sidewalls 150b, having sufficient height, prevents the new bedding for spilling out of the cage. The new bedding thus remains within the cage body 110, with sufficient bedding added to at least cover the top surfaces of rods 120. In this manner, the rodent is afforded a more natural bedding environment than typical metal wire flooring. With sufficient bedding in place, sliding top panel 130 is then repositioned within channel 112 (ensuring that any research equipment is secured within and passes through the opening of indentation 132) such that the rodent cannot jump out of the cage. In this manner, daily cleaning of the rodent cage is possible without requiring handling of the rodent or removal of any tethered equipment. The clear acrylic construction further allows unobstructed viewing and video recording of the subject animal.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A non-human animal cage comprising:
a) a cage body having a top end, side walls and a floor proximate a bottom end of said cage body; and
b) a bottom tray having upwardly extending tray sidewalls wherein the tray is proportioned so that said bottom end of the cage body rests within the tray during use,
wherein said floor of said cage body is comprised of a plurality of bars extending from one side wall to an opposing side wall, wherein said floor includes a spaced opening between each adjacent bar, and wherein said spaced opening is configured such that animal bedding may pass through the spaced opening when said bottom tray is separated from said cage body.

2. The non-human animal cage in accordance with claim 1 wherein said plurality of bars are cylindrical.

3. The non-human animal cage in accordance with claim 1 wherein said plurality of bars extend generally parallel to said bottom end of said cage body.

4. The non-human animal cage in accordance with claim 1 wherein said upwardly extending tray sidewalls extend above the cage body floor when the cage body rests within the tray during use.

5. The non-human animal cage in accordance with claim 1 wherein the side walls of said cage body are constructed of clear plastic.

6. The non-human animal cage in accordance with claim 5 wherein the clear plastic is a non-permeable clear acrylic plastic.

7. The non-human animal cage in accordance with claim 1 further including a top panel, wherein said side walls of said cage body have interior surfaces, wherein the interior surfaces of two opposing side walls include channels and wherein said channels are configured to slidably receive a respective edge of said top panel to enclose said top end of said cage body.

8. The non-human animal cage in accordance with claim 7 wherein a third side wall includes a channel to receive a respective edge of said top panel.

9. The non-human animal cage in accordance with claim 7 wherein said top panel includes an opening therethrough for passage of a tether and wherein said opening intersects with one edge of said top panel to form a slot.

10. The non-human animal cage in accordance with claim 8 wherein a fourth side wall opposite said third side wall includes a top edge and said top panel includes a groove configured to receive said top edge when said top end of said cage body is enclosed by said top panel.

11. A cage for housing a non-human animal, the cage comprising:
a) a cage body having an open bottom end and an open top end defined by opposing side panels having an integral channel formed therein proximate the top end, a back panel, and a front panel having a top edge terminating below the channel, and a floor proximate the bottom end wherein the floor is comprised of a plurality of rods arranged generally in parallel spaced relation with one another thereby defining lateral spaces between successive rods;
b) a top panel slidably engaged within the channel and having an opening therethrough wherein said opening intersects with a panel edge of the top panel so as to allow slidable removal of the top panel from the cage body without requiring removal of laboratory equipment; and
c) a tray having a bottom and upwardly extending sidewalls wherein the tray is proportioned so that the cage body rests within the tray during use and the tray sidewalls extend above the floor when the cage body rests within the tray.

12. The cage in accordance with claim 11 wherein the cage body, top panel and tray are constructed of a non-permeable clear acrylic plastic.

13. A method of cleaning an animal cage, the cage being charged with a non-human animal and bedding material, the method comprising the steps of:
a) providing the cage wherein the cage comprises a cage body having an open bottom end, a floor proximate said bottom end and sidewalls, and a tray having a bottom and upwardly extending tray sidewalls wherein said floor is comprised of a plurality of bars extending from one side wall to an opposing side wall and a spaced opening between each adjacent bar, and wherein the tray is configured so that the cage body rests within the tray during use;
b) separating the cage body from the tray thereby permitting soiled bedding material to pass through the spaced opening to be collected in the tray;
c) emptying collected soiled bedding material from the tray; and
d) returning the cage body to the emptied tray.

14. The method in accordance with claim 13 wherein said non-human animal is not removed from the cage before the cage body is separated from the tray.

15. The method in accordance with claim 13 wherein said cage further includes a top panel slidably engageable with said cage body, the method comprising the further steps of:
a) slidably removing the top panel from the cage body;
b) placing fresh bedding within the cage body to substantially cover said bars of said floor; and
c) slidably engaging the top panel with said cage body.

16. The method in accordance with claim 15 wherein said non-human animal is connected to equipment exterior of said cage via a tether and wherein said tether is not disconnected from said non-human animal through the step of slidably engaging the top panel with said cage body.

17. The method in accordance with claim 15 wherein a sidewall of said cage body includes a top edge and said top panel includes a groove adjacent said top edge and wherein said groove is configured to receive said top edge when said top panel is engaged with said cage body, the method including the further step of lifting the top panel away from the cage body before slidably removing the top panel from the cage body to disengage said top edge from said groove.
